(19) United States
(12) Patent Application Publication
(10) Pub. No.: US 2026/0270711 A1
(43) Pub. Date: Sep. 10, 2026

(54) ASSOCIATION IDENTIFIER GENERATION IN ENHANCED PRIVACY WIRELESS NETWORKS

(71) Applicant: Cisco Technology, Inc., San Jose, CA (US)

(72) Inventors: Domenico FICARA, Essertines-Sur-Yverdon (CH); Federico LOVISON, Fontanelle (IT); Ugo M. CAMPIGLIO, Morges (CH); Javier I. CONTRERAS ALBESA, Sant Cugat del Valles (ES); Jerome HENRY, Pittsboro, NC (US)

(21) Appl. No.: 19/559,555

(22) Filed: Mar. 6, 2026

Related U.S. Application Data
(60) Provisional application No. 63/776,865, filed on Mar. 24, 2025.
(60) Provisional application No. 63/768,804, filed on Mar. 7, 2025.

(51) Int. Cl. H04W 12/61; H04W 72/0446

(52) U.S. Cl. CPC H04W 12/61; H04W 72/0446

(57) ABSTRACT

The present disclosure provides techniques for identifying and transmitting future association identifiers (AIDs) for wireless stations (STAs) in a Basic Service Set, including identifying, by an access point (AP), a frame to be transmitted. The AP may determine, during a current epoch, a first AID for a first station. The AP may determine a first epoch discriminator, such as an even/odd bit, of the current epoch with respect to the first AID. The AP may transmit the first frame comprising the first AID and the first epoch discriminator, such as transmitting the first frame to the first station.

### CROSS-REFERENCE TO RELATED APPLICATIONS

This application claims benefit of co-pending United States provisional patent application Serial No. 63/768,804 filed Mach 7, 2025 and co-pending United States provisional patent application Serial No. 63/776,865 filed March 24, 2025. The aforementioned related patent applications are herein incorporated by reference in their entirety

### TECHNICAL FIELD

Embodiments presented in this disclosure generally relate to wireless networks. More specifically, embodiments disclosed herein relate to identifying enhanced-security wireless associations.

### BACKGROUND

Modern wireless networks may employ a number of security features aimed at enhancing the security of the network and its clients. Basic Service Set (BSS) privacy enhancements (BPE) and Client Privacy Enhancement (CPE) techniques enable various BSSs, and clients therein, to preserve privacy and avoid outside tracking of the network, such as through attempting to anonymize identifiers of various devices in the network, such as access points (APs) or wireless stations (STAs), by changing identifiers at various time periods.

As a result of retransmissions and buffered frames, a transition period is necessary to ensure that frames are not lost in the period of time immediately after an identifier has changed. However, as a result of the transition period, and the need to avoid collisions, an identifier, such as an Association Identifier (AID), cannot be directly used in the next time period, causing the AID domain space of an AP to be reduced by half.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for identifying association identifier information in a wireless network, according to some embodiments of the present disclosure.

FIG. 2 depicts an example environment for determining association identifiers across transitions periods, according to some embodiments of the present disclosure.

FIG. 3 is a flow diagram depicting an example method for determining and transmitting association identifier information to a wireless station, according to some embodiments of the present disclosure.

FIG. 4 is a flow diagram depicting an example method for creating a frame to transmit association identifier information, according to some embodiments of the present disclosure.

FIG. 5 is a flow diagram depicting an example method for identifying association identifier information across a multitude of groups, according to some embodiments of the present disclosure.

FIG. 6 is a flow diagram depicting an example method for identifying association identifier information, according to some embodiments of the present disclosure.

FIG. 7 depicts an example computing device configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method. The method includes: identifying, by an access point (AP), a first frame to be transmitted; determining, by the AP and during a current epoch, a first association identifier (AID) for a first station; determining, by the AP, a first epoch discriminator of the current epoch with respect to the first AID; and transmitting, by the AP, the first frame comprising the first AID and the first epoch discriminator.

Other embodiments provide an access point comprising one or more memories and one or more processors communicatively coupled to the one or more memories, wherein the one or more processors are configured to, individually or collectively, perform the aforementioned method, as well as those described herein; and a non-transitory computer readable storage medium comprising instructions that when executed configure one or more processors of an access point to perform the aforementioned methods as well as those described herein.

### Example Embodiments

In some embodiments of the present disclosure, techniques are provided to identify AIDs and associated time period (e.g., epoch) discriminators for various wireless STAs within a BPE-enabled and/or CPE-enabled network (generally, a privacy enhanced network).

Many wireless deployments are comprised of Basic Service Sets, each comprising one AP and various wireless STAs connected to the AP. Upon authenticating with an AP, a wireless STA may transmit an association request to the AP. Upon receiving the association request and determining that the association request should be accepted, the AP may create or otherwise determine an AID for the wireless STA, and respond with an association response, in turn granting the STA access to the AP and network.

In modern privacy enhanced networks, an AP may periodically change (e.g., at a random or set frequency) AIDs in an attempt to anonymize the network and prevent identification and tracking of the client(s) by outside actors. While this may result in increased security for the network, a transition period is necessary to ensure that frames are not lost in the period of time immediately after an AID has changed, while frames may still be transmitting the former AID. As a result of the transition period, and the need to avoid collisions, in conventional networks, an AID cannot be directly reused in the next time period (e.g., because during the transition period, it would be possible for multiple packets destined for the same AID to be actually intended for two distinct devices), causing the AID domain space of an AP to be reduced by half.

Embodiments of the present disclosure provide methods, systems, and apparatuses for providing future AIDs and associated information to STAs in a BSS. More specifically, some embodiments are directed towards techniques enabling a network device (e.g., an AP) to identify AIDs across one or more future epochs (e.g., time periods) and transmit the future AID, alongside a discriminator for associated with the time period, element to a requesting STA. Such techniques enable an BSS to benefit from the enhanced privacy and security offered by BPE and CPE without facing connectivity issues associated with reducing the AID domain space.

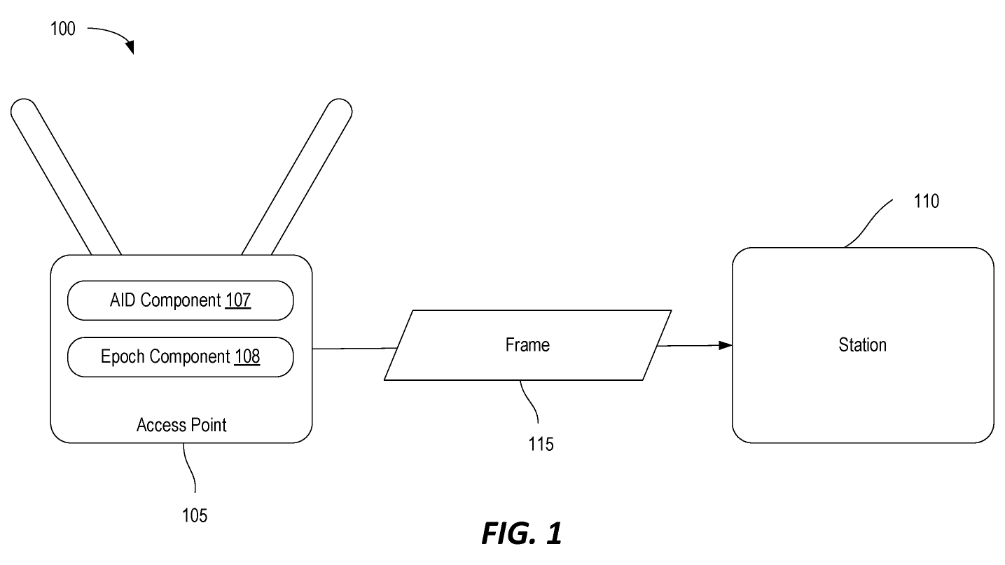

FIG. 1 depicts an example wireless environment 100 in which embodiments of the present disclosure may be implemented. As depicted, the environment 100 includes an AP 105 and a STA 110.

The AP 105 may generally correspond to an access point used to facilitate or provide connectivity in a wireless network (e.g., a wireless local area network (WLAN), e.g., using Wi-Fi protocols) and implement a BSS. The AP 105 may be configured to provide wireless access to one or more wireless STAs (e.g., client devices), such as the STA 110. STA 110 may generally be representative of any computing device capable of wireless communications using the WLAN, such as a smartphone, tablet, laptop, wearable computing device (e.g., smartwatch), and the like.

While only a single STA 110 and a single AP 105 are depicted in the example environment 100, in other examples, any number of APs 105 may be associated with any number of STAs 110 for active wireless data communications. That is, in some embodiments, the AP 105 may be concurrently connected to any number of client devices. In some embodiments, the AP 105 may operate as a single-link AP or as a multi-link device (MLD) AP, and each STA may operate as a single-link station (STA) or as an MLD STA.

In the environment 100, the AP 105 transmits a frame 115 to the STA 110. The frame 115 generally includes a set of information that is identified as being sent to the STA 110. In some examples, the frame 115 may be a management or control frame. That is, the frame 115 may generally be any frame that does not contain a Media Access Control (MAC) address or similar identifier for the STA 110, such that an AID may instead be included in the frame 115.

AP 105 may contain an AID component 107 and an epoch component 108, which may be configured to determine future AID information that can be transmitted within the frame 115 to the STA 110. That is, the AID component 107 may determine an AID for the STA 110 during a current epoch (e.g., time period). The epoch component 108 may then determine an epoch discriminator for the current epoch, with respect to the AID determined by the AID component 107. The AP 105 may embed the AID and the epoch discriminator within the frame 115, and transmit the frame 115 to the STA 110.

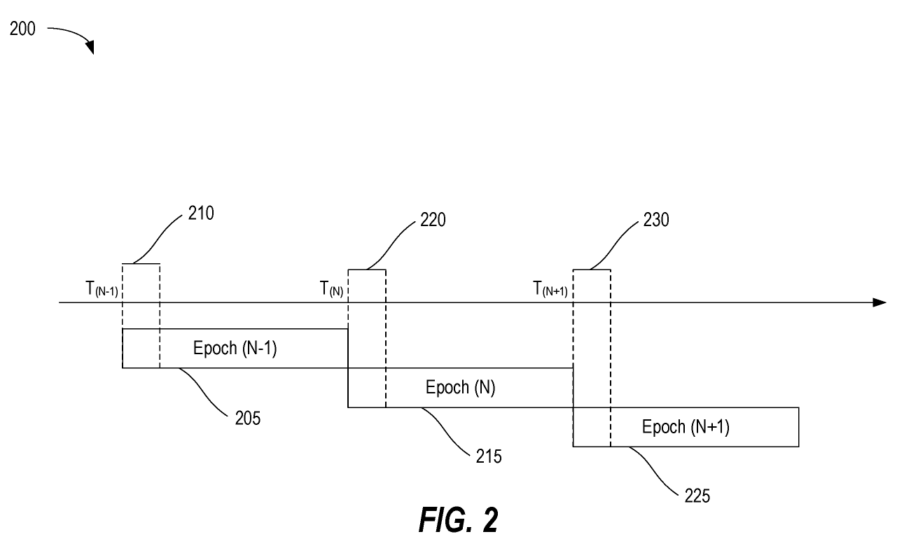

Upon determining that the AID should or will change (e.g., at a next epoch), the AID component 107 will determine a future AID for the STA 110 for the next epoch. In conventional systems, the AID determined by the AID component 107 would be restricted to an AID that was not used during the current time period or epoch, in order to prevent collisions resulting from multiple STAs using the same AID during an epoch transition period (discussed below with respect to FIG. 2). However, according to discriminator techniques of this disclosure, the epoch component 108 may generate or determine an epoch discriminator for the future epoch, with respect to the future AID. In this way, an AID may be reused across various epochs, as two different devices (e.g., the STA 110 and different STA of the AP 105) using the same AID in back to back epochs may be differentiated by the epoch discriminator.

In some embodiments, an AID may be reused in consecutive epochs. Accordingly, in such embodiments, the epoch discriminator may be a single bit, such as an “even/odd” discriminator bit, that flips across epochs. As one example, the epoch discriminator starts at 0 a first epoch, flips to 1 at a second epoch subsequent to the first epoch, and flips back to 0 at a third epoch subsequent to the second epoch (e.g., since there are no transient data frames containing the epoch discriminator at the first epoch). In such embodiments, each epoch may be referred to as an “even” or “odd” epoch, such that in the previous example, the first and third epochs may correspond to, or be identified as, “even” epochs (e.g., given the 0 status of the epoch discriminator), and the second epoch may correspond to or be identified as an “odd” epoch (e.g., given the 1 status of the epoch discriminator). In other examples, the epoch discriminator may be a longer form discriminator, such that the epoch discriminators across a first, second, and third epoch may each be different.

FIG. 2 depicts an example environment for determining association identifiers across transitions periods, according to some embodiments of the present disclosure. In the illustrated example, an AP (not depicted) may correspond to the AP 105 of FIG. 1. The AP may assign one or more AIDs, and associated information, to a STA (not depicted), such as the STA 110 of FIG. 1.

At epoch 205, a first STA (e.g., the STA 110 of FIG. 1) may connect to (e.g., and be associated with) the AP (e.g., the AP 105 of FIG. 1). At the epoch 205, the AP assigns the first STA an AID and determines an epoch discriminator for the epoch 205. During the transition period 210, the AP may transmit a frame to a second STA. In some examples, this frame may already be associated with a new AID determined for the second STA at the epoch 205 (e.g., the epoch at time (N-1)). However, in other examples, this frame may be still associated with an old AID determined for the second STA at the previous epoch (e.g., the epoch at time (N-2)).

During the transition period 210, the frames transmitted according to either the old AID or the new AID for the second STA may be accepted. However, as discussed above with respect to FIG. 1, there may be cases where frames are meant to be transmitted to a given AID that is associated with the second STA (e.g., at the previous epoch represented by the time (N-2)) and a different STA during the current epoch 205 (e.g., the epoch at time (N-1)). As such, the epoch discriminator assigned by the AP may be used to determine which STA should receive the frame. For example, the previous epoch would have a different epoch discriminator than the current epoch (e.g., the epoch 205), such that, if both the first STA and second STA had the same AID during the transition period 210, an epoch discriminator included in the frame corresponding to the epoch 205 would result in the frame properly being transmitted to the first STA, while an epoch discriminator associated with pervious epoch may result in the frame being transmitted to the second STA. However, at the end of the transition period 210, frames associated with previous AIDs (e.g., AIDs of the epoch at the time (N-2)) may no longer be accepted, and frames using the AID and respective epoch discriminator may not be transmitted to the corresponding STA.

According to BPE and/or CPE techniques, for the epoch 215, the AP may assign each STA (e.g., the first STA and the second STA) a new AID, which each respective STA will use for the duration of the epoch 215. As discussed above, during the transition period 220, traffic may be sent using the new AID and associated epoch discriminator (e.g., the AID and epoch discriminator of a STA at the epoch 215) and the previous AID and associated epoch discriminator (e.g., the AID and epoch discriminator at the epoch 205). Similarly, the AP may assign each STA a new AID and identify a respective epoch discriminator at the epoch 225. During the transition period 230, AIDs and associated epoch discriminators may be used from both the previous epoch at time N (e.g., the epoch 215) and the current epoch at time N+1 (e.g., the epoch 225). In some examples, the epoch discriminators associated with each epoch may be unique, while in other examples, the epoch discriminators may alternate according to a pattern. For example, the epoch discriminator may be the same at the epoch 205 and the epoch 225, while the epoch 215 may share an epoch discriminator with the epochs at times (N-2) and (N+2) (not depicted). As another example, such as where the epoch discriminator represents an even/odd bit, the epoch discriminator may “flip” at each epoch. for example, at the epoch 205, the epoch discriminator may be 0, representing that the epoch 205 is an “even” epoch. At the epoch 215, the epoch discriminator may “flip” to 1, representing that the epoch 215 is an “odd” epoch. Accordingly, the epoch discriminator flips once again for the epoch 225, such that the epoch discriminator is once again 0, representing that the epoch 225 is an “even” epoch.

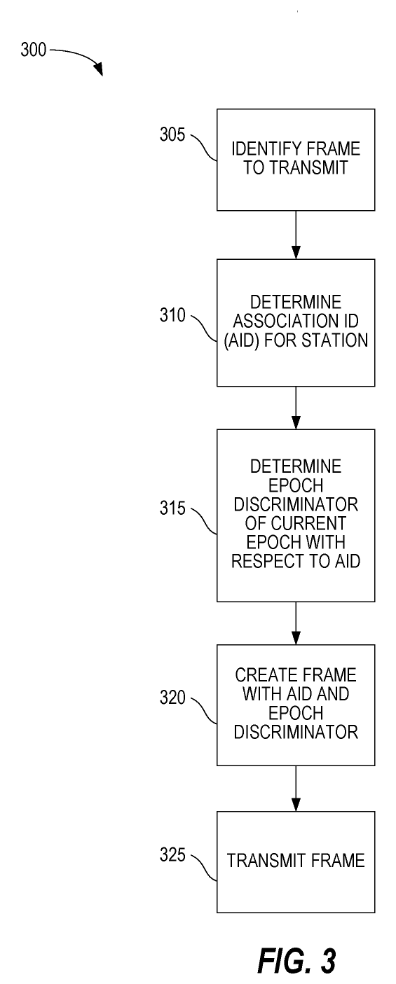

FIG. 3 is a flow diagram depicting an example method for determining and transmitting association identifier information to a wireless station, according to some embodiments of the present disclosure. The example method 300 may be performed by an AP, such as the AP 105 of FIG. 1.

At block 305, the AP device (e.g., the AP 105 of FIG. 1) identifies a frame to transmit to a wireless STA (e.g., the STA 110 of FIG. 1). In some examples, the AP may be configured to only identify specific types of frames. For example, the AP may be configured to only look for and identify specific types of management and/or control frames that do not contain a MAC address identifying the wireless STA, while refraining from looking for data frames, which may already contain necessary identification information for the given wireless STA.

At block 310, the AP, or a component therein (e.g., the AID component 107 of FIG. 1) determines an AID for the wireless STA. In some examples, the AP device may maintain a local (e.g., on-device) list with information relating to each AID currently assigned to a STA associated with the AP. In such examples, the AP device may use the list to determine an AID to assign to a given STA. In some examples, the AID may be determined in a random or pseudo-random manner, while in other examples, the AID may be determined in a set manner (e.g., sequentially). In some examples, the AID may be determined from, or otherwise based on, a list of AIDs previously transmitted to the STA. That is, in some examples, the AP may transmit a list of multiple (e.g., two or more) AIDs to the STA. In some examples, the list of AIDs may be pre-determined to be associated with a given epoch and/or epoch discriminator, as described below. In other examples, the AP may use the list to determine (e.g., select) an AID from the list to use for the next epoch.

In accordance with one or more aspects of the present disclosure, the AID of a STA may periodically change (e.g., at a random or set frequency) to increase the security of the network and connected devices. In some examples, at such times where the AID of a STA changes (e.g., from a previous epoch to a current epoch, such as from the epoch 205 of FIG. 2 to the epoch 215 of FIG. 2), each AID assigned to a STA at the previous epoch may be recalled or otherwise unreserved, such that the AID may be assigned to a STA for the current epoch. As such, at block 310, the AP may determine the AID for a wireless STA from the full AID domain space for the current epoch (not including AIDs assigned to other STAs at the same epoch).

At block 315, the AP, or a component therein (e.g., the epoch component 108 of FIG. 1) determines an epoch discriminator of the current epoch, with respect to the AID determined by the AP at block 310. An epoch discriminator may correspond to the epoch group at the time at which the AID was determined and/or formatted into the frame, as discussed below. As discussed above with respect to the example environment 200 of FIG. 2, in some examples, transition periods between epochs (e.g., the transition period 220 of FIG. 2, corresponding to a period of time between the epoch 205 and the epoch 215) last only a partial time of the epoch.

In such examples, there may not be a time at which frames may be analyzed for the same AID across three or more consecutive epochs, as frames may only “leak” from a previous epoch to the current epoch. As such, in some examples, the epoch discriminator may be a single bit that specifies whether the AID was identified in a first group of epochs or a second group of epochs. For example, the AP may determine an “odd” set of epochs (e.g., the epoch 205 and the epoch 225 of FIG. 2, at times (N-1) and (N+1), respectively) and an “even” set of epochs (e.g., the epoch 215 at the time N), such that the epoch discriminator changes (e.g., flips) at every epoch. For example, in the example environment 200 of FIG. 2, an epoch discriminator may be 0 at the epoch 205, and flip to 1 at the epoch 215, and flip back to 0 at the epoch 225.

In other examples, the single bit may represent whether the AID belongs to a current epoch (e.g., identified by a 0) or a previous epoch (e.g., identified by a 1). In other examples, the epoch discriminator may be randomly or pseudo-randomly determined for each epoch, while in additional examples, the epoch discriminator may be determined based on a set of information, such as in a sequential manner (e.g., based on a time or associated factor determined by the AP).

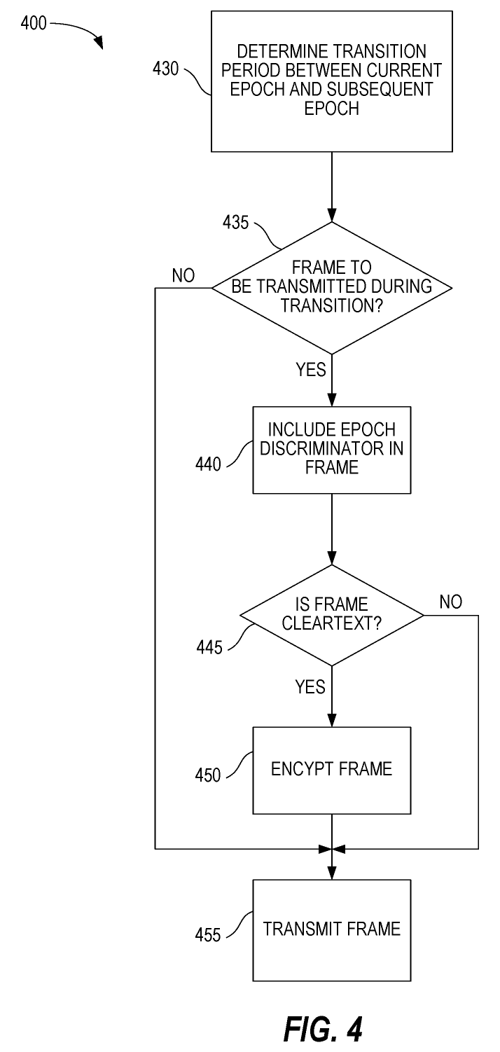

At block 320, the AP creates the frame comprising the epoch discriminator determined at block 315 and the AID determined at block 310 to the frame identified at block 305. In some examples, the epoch discriminator may be included in the frame independently from the AID (e.g., as an independent byte or field). In other examples, the epoch discriminator may be added (e.g., appended, prepended, etc.) to the AID field. Additionally, while the example method 300 of FIG. 3 depicts the frame as including the epoch discriminator, in some examples, described in more detail in FIG. 4 (below), the epoch discriminator may not be included in the frame. At block 325, the AP transmits the frame to the associated wireless STA.

FIG. 4 is a flow diagram depicting an example method for creating a frame to transmit association identifier information, according to some embodiments of the present disclosure. The method 400 provides more detail for block 320 of FIG. 3, such that each operation of the method 400 may be included in the operation of block 320 of FIG. 3 (e.g., by which the AP generates the frame). Accordingly, the example method 400 may be performed by an AP, such as the AP 105 of FIG. 1.

At block 430, the AP device determines a transition period between the current epoch and the subsequent epoch. As discussed above, with respect to FIGS. 2 and 3, the transition period may represent a period of time for which AIDs transmitted may be from the current epoch and another epoch. For instance, in the example of FIG. 2, wherein the current epoch is the epoch 215, and a frame is being transmitted during the transition period 220, the transition period 220 represents the period of time at which AIDs from the current epoch (e.g., the epoch 215) and the previous epoch (e.g., the epoch 205) may be used. As another example, wherein the current epoch is the epoch 205, and the frame is being transmitted during the epoch 205, the transition period 220 represents the period of time at which AIDs form the current epoch (e.g., the epoch 205) and the subsequent epoch (e.g., the epoch 215) may be used.

In some examples, the time for which the transition period is active may be random, while in other examples, the time for which the transition period is active may be set or static across epochs. The transition period may be any amount of time less than or equal to the length of the corresponding epochs. For example, if an epoch length is five minutes long, a transition period may be no longer than five minutes, starting at the beginning of the subsequent epoch.

At block 435, the AP device determines whether the frame will be sent during a transition period between the current epoch and the subsequent epoch. For example, in the example environment 200 of FIG. 2, wherein the current epoch refers to the epoch 215, the AP device may determine whether the frame will be transmitted during the transition period 230 between the epoch 215 and the epoch 225.

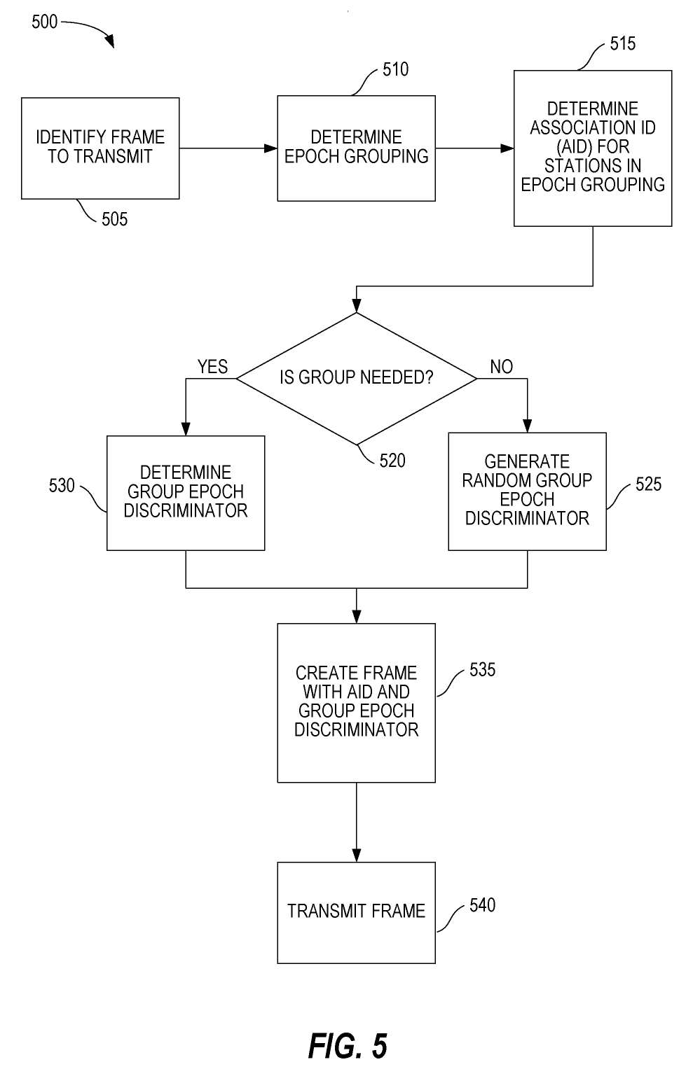

If the frame is not to be transmitted during the transition period, the AP may proceed according to the “NO” branch to block 455, discussed below. If the frame is to be transmitted during the transition period, the AP may proceed according to the “YES” branch to block 440, wherein the AP includes the epoch discriminator in the frame. In some examples, the epoch discriminator may be included as a single bit added (e.g., appended, prepended, etc.) to the AID, or to information associated with the AID. In other examples, the epoch discriminator may be included in a bitfield, wherein bits in the bitfield represent different epoch groups (as discussed below with respect to FIG. 5). The bitfield may be included generally in the frame, such as by being added to a new Information Element (IE) transmitted in the frame. In additional examples, the epoch discriminator may be included as a Traffic Indication Map (TIM). Additionally, while depicted in the example method 500 as adding the epoch discriminator to the frame, in some examples, the epoch discriminator may be appended directly to the AID. For example, the AP may use a formula, such as AID | epoch discriminator bit <<12, to directly append the epoch group discriminator to the AID.

At block 445, the AP determines whether the frame is cleartext. If the AP determines that the frame is cleartext, the AP may proceed according to the “YES” branch to block 450, at which the AP encrypts or otherwise protects information containing the epoch discriminator, such as an Information Element, such that the epoch discriminator may only be accessible to STAs that are already associated with the AP. For example, the AP may encrypt the Information Element with a Group Temporal Key (GTK). If the frame is not cleartext (e.g., already has some form of encryption or protection), the AP may proceed according to the “NO” branch to block 455.

At block 455, the AP transmits the frame (e.g., to the STA).

FIG. 5 is a flow diagram depicting an example method for identifying association identifier information across a multitude of groups, according to some embodiments of the present disclosure. The example method 500 may be performed by an AP, such as the AP 105 of FIG. 1.

At block 505, an access point (e.g., the AP 105 of FIG. 1) identifies a frame to transmit to a wireless STA (e.g., the STA 110 of FIG. 1). In some examples, the AP may be configured to only identify specific types of frames. As discussed above, in some examples, the AP may be configured to only look for and identify management and/or control frames, while refraining from looking for frames, which may already contain necessary identification information (e.g., a MAC address) for a given wireless STA.

At block 510, the AP, or a component therein (e.g., the epoch component 108 of FIG. 1) determines an epoch grouping. That is, various wireless STAs of the BSS may fall into one or more epoch groupings, such that every STA of the same epoch grouping transitions to a new AID at the same time (e.g., follows the same epoch transitions). In some examples, an AP may only have one epoch grouping for the totality of the STAs associated with the AP, while in other examples, there may be multiple different epoch groupings associated with the AP, such that STAs in different epoch groups may change parameters (e.g., transition to a new AID) at different times. In some examples, an epoch grouping may include multiple wireless STAs, while in other examples, an epoch grouping may include only a single wireless STA. In some examples, an epoch grouping may be pre-determined, such that a grouping is set to change at a certain epoch schedule, but may contain no wireless STAs yet (e.g., no STAs assigned to the grouping yet). In some examples, a STA may choose which epoch group to join, while in other examples, the AP may determine what group a STA is assigned to.

At block 515, the AP, or a component therein (e.g., the AID component 107 of FIG. 1) determines an AID for each station in the epoch grouping. For example, the AP may determine the future AID for each station in the epoch grouping, such that the AP may determine a new AID for each wireless STA in the epoch grouping at the same time (e.g., at, or prior to, a transition period indicating the end of the epoch, such as the transition period 220 of FIG. 2).

At block 520, the AP determines whether or not the epoch grouping is needed. That is, the AP determines whether or not the epoch discriminator is needed for the group. For example, the AP may determine whether the group is used at all in the BSS (e.g., whether the epoch grouping is empty or contains at least one STA). As another example, the AP may determine whether at least one STA of the epoch group has any traffic, or whether no STAs have a frame to transmit and/or receive.

If the group is needed, the AP may proceed according to the “YES” branch to block 530. At block 530, the AP determines an epoch discriminator for the epoch grouping. As described above, the epoch group discriminator for the epoch grouping refers to the epoch of the associated group, such that the epoch group discriminator for a first group may be different than the epoch group discriminator for a second group. For example, where the epoch discriminator is an even/odd bit, as described above, the epoch group discriminator for a first group may correspond to an even epoch, and may be represented by an even bit (e.g., a 0 value), while a second group may be at an odd epoch, and epoch group discriminator may be represented by an odd bit (e.g., a 1 value). If the group is not needed, the AP may proceed according to the “NO” branch to block 525. At block 525, the AP generates a random group epoch discriminator for the epoch group, to improve the security of the network and increase the difficulty for a device to determine when epoch transitions occur in the network.

At block 535, the AP creates a frame (e.g., the frame 115 of FIG. 1) comprising the AID and the epoch group discriminator. Although depicted in the example method 500 as including the epoch group discriminator, as determined at blocks 525 or 530, in other examples, the AP may determine to not include the epoch discriminator, based on a determination at block 520. For example, the AP may determine to include the epoch discriminator in the frame if the group is needed (e.g., if traffic is shown a TIM, if the group is occupied by at least one STA, etc.). At block 540, the AP transmits the frame to the associated wireless STA.

In some examples, the operations of the example method 500 may include additional steps. For instance, in some examples, the epoch group discriminator for each group may be included in a bitfield. That is, bits representing different groups are grouped in a bitfield in which the position of the bit determines the group it represents. In some examples, the AP may be configured to only include the bitfield in certain frames, such as management and/or control frames that rely on the AID to identify a STA. For example, the AP may be configured to include the bitfield representing each group epoch discriminator in frames such as a beacon frame, a multi-STA Block-Ack frame, a broadcast poll frame, a multi-link Block-Ack frame, a trigger frame, or a Neighbor Discovery Protocol frame. In other examples, one or more TIMs may be used instead of a bitfield. For example, in a beacon frame, a TIM may be duplicated, such that multiple TIMs may represent various epoch groups, and/or the position of STA in an epoch group (e.g., in a two-epoch system, as described above with respect to FIG. 2). In such embodiments, in some examples, the TIMs may only be included in transition periods (e.g., the transition period 220 of FIG. 2), while in other examples, the TIMs may always be included.

In some examples, such as when a frame is a multi-STA Block Ack, a per-group epoch discriminator bit may be shared. In some examples of this embodiment, the epoch discriminator bit may not be encoded in broadcast frames, but, instead, the frame may include a partial virtual bitmap of the epoch group discriminators, based on their position in epoch sequence. For example, as discussed above, when STAs may alternate between an “even” and “odd” epoch, the partial virtual bitmap may only include STAs and/or epoch groups that are currently in one position of the epoch period (e.g., all in “odd,” all in “even,” etc.). In some examples, information related to the epoch groupings may be compressed using a compression algorithm, such as using run-length encoding, Huffman coding, or any other general compression algorithm known in the art.

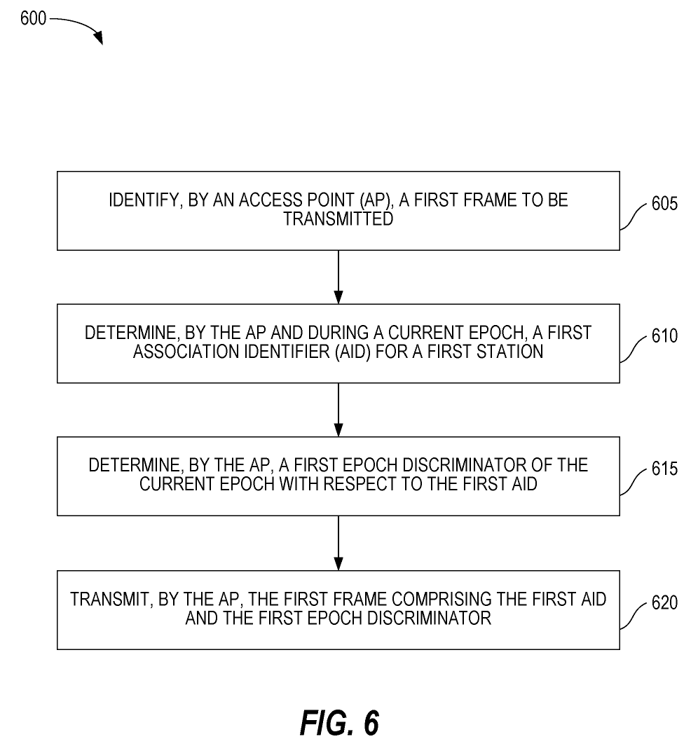

FIG. 6 is a flow diagram depicting an example method for identifying association identifier information, according to some embodiments of the present disclosure. The example method 600 may be performed by an AP, such as the AP 105 of FIG. 1.

At block 605, an access point (e.g., the AP 105 of FIG. 1) identifies a first frame to be transmitted. In some examples, block 605 may correspond to, or provide additional or alternative details for, the operations discussed above with reference to block 305 of FIG. 3 or block 505 of FIG. 5.

At block 610, the access point determines, during a current epoch, a first AID for a first station (e.g., the STA 110 of FIG. 1). In some examples, block 610 may correspond to, or provide additional or alternative details for, the operations discussed above with reference to block 310 of FIG. 3.

At block 615, the access point determines a first epoch discriminator of the current epoch, with respect to the first AID. In some examples, block 615 may correspond to, or provide additional or alternative details for, the operations discussed above with reference to block 315 of FIG. 3.

At block 620, the access point transmits the first frame (e.g., the frame 115 of FIG. 1) comprising the first AID and the first epoch discriminator. In some examples, block 620 may correspond to, or provide additional or alternative details for, the operations discussed above with reference to block 325 of FIG. 3. In such embodiments, in some examples, block 620 may include additional operations, such as the operations discussed above with reference to block 320 of FIG. 3.

In some embodiments, transmitting the frame comprising the first AID and the first epoch discriminator comprises adding the first epoch discriminator to the first AID.

In some embodiments, the operations of the example method 600 further adding the first epoch discriminator to a body of the first frame.

In some embodiments, the first epoch discriminator comprises an epoch bit in an Information Element (IE) of the first frame. In such embodiments, the operations of transmitting the frame may include encrypting the IE, based on determining the first frame is a cleartext frame. In such embodiments, the operations may correspond to, or provide additional or alternative details for, the operations discussed above with reference to blocks 445 and 450 of FIG. 4.

In some embodiments, the operations of the example method 600 further include determining a transition period between the current epoch and a subsequent epoch, with respect to the first AID. In such embodiments, the operations of transmitting the frame comprising the first epoch discriminator includes determining that the first frame will be transmitted during the transition period and based on determining the first frame will be transmitted during the transition period, including the first epoch discriminator with the frame. In such embodiments, the operations may correspond to, or provide additional or alternative details for, the operations discussed above with reference to blocks 435 and 440 of FIG. 4.

In some embodiments, the frame is transmitted to at least two stations across a plurality of epoch groups. In such embodiments, the operations of the example method 600 further include determining a set of group epoch discriminators, wherein each group epoch discriminator corresponds to a respective epoch group of the plurality of epoch groups and including the set of group epoch discriminators in the first frame. In such embodiments, the operations may correspond to, or provide additional or alternative details for, the operations discussed above with reference to blocks 510, 520, 530, 535, and 540 of FIG. 5. Additionally, in such embodiments, the first epoch discriminator may be included in the first frame, in response to determining that the first station has traffic visible in a traffic indication map, such that the operations may correspond to, or provide additional or alternative details for, the operations discussed above with reference to blocks 520 and 530 of FIG. 5.

Further, in such embodiments, the AP may include the first epoch discriminator in the first frame in response to determining that the current epoch satisfies a notification criterion, such that the operations may correspond to, or provide additional or alternative details for, the operations discussed above with reference to blocks 520 and 530 of FIG. 5. Additionally, in such embodiments, the operations of determining the set of group epoch discriminators includes determining that a first group does not contain an active station and generating a randomized group epoch discriminator for the first group, such that the operations may correspond to, or provide additional or alternative details for, the operations discussed above with reference to blocks 520 and 525 of FIG. 5.

In some embodiments, the operations of the example method 600 further include determining a second AID for the first station for a subsequent epoch, relative to the current epoch and determining a second epoch discriminator for the second AID. In such embodiments, in some examples, the current epoch may represent an even epoch, the subsequent epoch may represent an odd epoch, and the second epoch discriminator may represent an inverse of the first epoch discriminator.

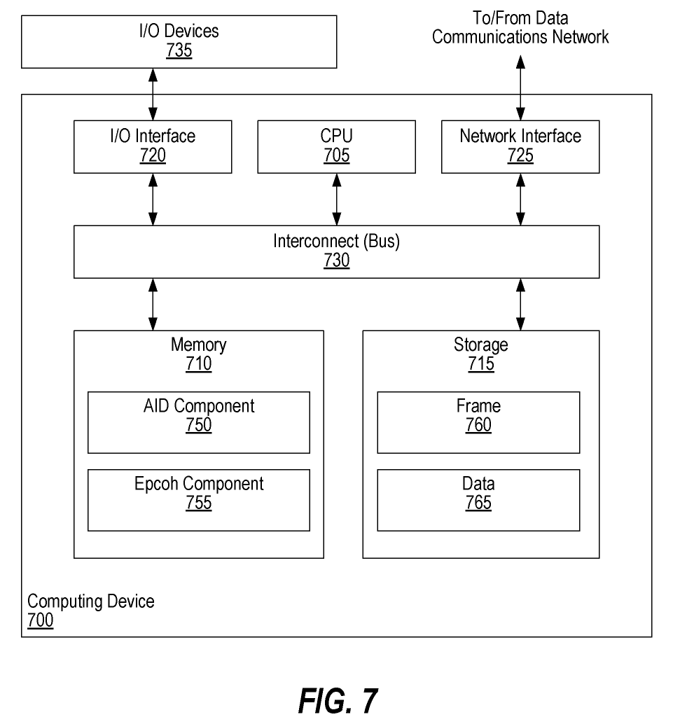

FIG. 7 depicts an example network device 700 configured to perform various aspects of the present disclosure, according to some embodiments of the present disclosure. Although depicted as a physical device, in embodiments, the computing device 700 may be implemented using any number of virtual or physical device(s) (e.g., in a cloud environment). In one embodiment, the computing device 700 corresponds to or implements an AP, such as the AP 105 of FIGS. 1 or the APs discussed above with reference to FIGS. 2-6.

As illustrated, the computing device 700 includes a CPU 705, a memory 710, a storage 715, a network interface 725, and one or more I/O interfaces 720. In the illustrated embodiment, the CPU 705 retrieves and executes programming instructions stored in the memory 710, as well as stores and retrieves application data residing in the memory 710, the storage 715, or both. The CPU 705 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, the memory 710, the network interface(s) 725, and the I/O interface(s) 720 are communicatively coupled by one or more buses 730.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 is generally included to be representative of a random-access memory. The memory 710 may store processor-executable software code containing instructions that, when executed by the CPU 705, enable the computing device 700 to perform various functions described herein for wireless communication. The memory 710 may include random access memory (RAM) and read-only memory (ROM).

As depicted, the memory 710 includes a AID component 750 and an epoch component 755. Although depicted as discrete components for conceptual clarity, in embodiments, the operations of the depicted components (and others not illustrated) may be combined or distributed across any number of components. Further, although depicted as software residing in the memory 710, in embodiments, the operations of the depicted components (and others not illustrated) may be implemented using hardware, software, or a combination of hardware and software.

The AID component 750 may generally correspond, and operate in a similar manner to, the AID component 107 of AP 105 of FIG. 1. The AID component 750 may be configured to determine an AID for a STA (e.g., the STA 110 of FIG. 1) during a current epoch (e.g., time period). Upon determining that the AID should change (e.g., at a next epoch), the AID component 750 may be configured to generate a future AID for the STA at the next (e.g., future) epoch, as determined by the epoch component 755.

The epoch component 755 may generally correspond, and operate in a similar manner to, the epoch component 108 of AP 105 of FIG. 1. The epoch component 750 may be configured to determine epoch(s) associated with an AID generated by the AID component 750, representing time(s) at which a STA will switch to using a new AID. The epoch component 755 may determine an epoch discriminator associated with the epoch of the new AID, and may include the epoch discriminator in a response with the AID.

The computing device 700 may generate one or more frames or responses, such as the frame 760, to STAs (e.g., STA 110 of FIG. 1), providing the STA with information on a current and/or future AID and the associated epoch discriminator. Although depicted as residing in the storage 715, the frame 760 of the computing device 700 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
identifying, by an access point (AP), a first frame to be transmitted;
determining, by the AP and during a current epoch, a first association identifier (AID) for a first station;
determining, by the AP, a first epoch discriminator of the current epoch with respect to the first AID; and
transmitting, by the AP, the first frame comprising the first AID and the first epoch discriminator.

2. The method of claim 1, wherein transmitting the first frame comprising the first AID and the first epoch discriminator comprises adding the first epoch discriminator to the first AID.

3. The method of claim 1, wherein the first epoch discriminator comprises an epoch bit in an Information Element (IE) of the first frame.

4. The method of claim 1, further comprising:
determining a transition period between the current epoch and a subsequent epoch, with respect to the first AID, and wherein transmitting the first frame comprising the first epoch discriminator comprises:
determining that the first frame will be transmitted during the transition period; and
based on determining the first frame will be transmitted during the transition period, including the first epoch discriminator with the first frame.

5. The method of claim 1, wherein the first frame is transmitted to at least two stations across a plurality of epoch groups, the method further comprising:
determining a set of group epoch discriminators, wherein each group epoch discriminator corresponds to a respective epoch group of the plurality of epoch groups; and
including the set of group epoch discriminators in the first frame.

6. The method of claim 5, wherein determining the set of group epoch discriminators comprises:
determining that a first group does not contain an active station; and
generating a randomized group epoch discriminator for the first group.

7. The method of claim 1, further comprising:
determining a second AID for the first station for a subsequent epoch, relative to the current epoch; and
determining a second epoch discriminator for the second AID.

8. The method of claim 7, wherein the current epoch represents an even epoch, the subsequent epoch represents an odd epoch, and wherein the second epoch discriminator represents an inverse of the first epoch discriminator.

9. An access point comprising:
one or more memories; and
one or more processors communicatively coupled to the one or more memories, wherein the one or more processors are configured to, individually or collectively, perform operations comprising:
identifying, by an access point (AP), a first frame to be transmitted;
determining, by the AP and during a current epoch, a first association identifier (AID) for a first station;
determining, by the AP, a first epoch discriminator of the current epoch with respect to the first AID; and
transmitting, by the AP, the first frame comprising the first AID and the first epoch discriminator.

10. The access point of claim 9, wherein transmitting the first frame comprising the first AID and the first epoch discriminator comprises adding the first epoch discriminator to the first AID.

11. The access point of claim 9, wherein the first epoch discriminator comprises an epoch bit in an Information Element (IE) of the first frame.

12. The access point of claim 9, the operations further comprising:
determining a transition period between the current epoch and a subsequent epoch, with respect to the first AID, and wherein transmitting the first frame comprising the first epoch discriminator comprises:
determining that the first frame will be transmitted during the transition period; and
based on determining the first frame will be transmitted during the transition period, including the first epoch discriminator with the first frame.

13. The access point of claim 9, wherein the first frame is transmitted to at least two stations across a plurality of epoch groups, the operations further comprising:
determining a set of group epoch discriminators, wherein each group epoch discriminator corresponds to a respective epoch group of the plurality of epoch groups; and
including the set of group epoch discriminators in the first frame.

14. The access point of claim 13, wherein determining the set of group epoch discriminators comprises:
determining that a first group does not contain an active station; and
generating a randomized group epoch discriminator for the first group.

15. The access point of claim 9, the operations further comprising:
determining a second AID for the first station for a subsequent epoch, relative to the current epoch; and
determining a second epoch discriminator for the second AID.

16. A non-transitory computer readable storage medium comprising instructions that when executed configure one or more processors of an access point to perform operations comprising:
identifying, by an access point (AP), a first frame to be transmitted;
determining, by the AP and during a current epoch, a first association identifier (AID) for a first station;
determining, by the AP, a first epoch discriminator of the current epoch with respect to the first AID; and
transmitting, by the AP, the first frame comprising the first AID and the first epoch discriminator.

17. The non-transitory computer readable storage medium of claim 16, wherein transmitting the first frame comprising the first AID and the first epoch discriminator comprises adding the first epoch discriminator to the first AID.

18. The non-transitory computer readable storage medium of claim 16, the operations further comprising:
determining a transition period between the current epoch and a subsequent epoch, with respect to the first AID, and wherein transmitting the first frame comprising the first epoch discriminator comprises:
determining that the first frame will be transmitted during the transition period; and
based on determining the first frame will be transmitted during the transition period, including the first epoch discriminator with the first frame.

19. The non-transitory computer readable storage medium of claim 16, wherein the first frame is transmitted to at least two stations across a plurality of epoch groups, the operations further comprising:
determining a set of group epoch discriminators, wherein each group epoch discriminator corresponds to a respective epoch group of the plurality of epoch groups; and
including the set of group epoch discriminators in the first frame.

20. The non-transitory computer readable storage medium of claim 16, the operations further comprising:
determining a second AID for the first station for a subsequent epoch, relative to the current epoch; and
determining a second epoch discriminator for the second AID.
